(19) United States
(12) Patent Application Publication
(10) Pub. No.: US 2022/0161846 A1
(43) Pub. Date: May 26, 2022

(54) ENHANCED VEHICLE STEERING OPERATION

(71) Applicant: Ford Global Technologies, LLC, Dearborn, MI (US)

(72) Inventors: Hiva Ghanbari, West Bloomfield, MI (US); Victor Yu, Dearborn, MI (US); Milad Zafar Nezhad, Southfield, MI (US); Wayne Zhang, Nanjing/Jiangning Development Zone (CN)

(73) Assignee: Ford Global Technologies, LLC, Dearborn, MI (US)

(21) Appl. No.: 17/103,988

(22) Filed: Nov. 25, 2020

(51) Int. Cl. B62D 6/00; B60W 40/08; B60W 30/14; B60W 30/12; B60W 10/20

(52) U.S. Cl. CPC B62D 6/007; B60W 40/08; B60W 30/14; B60W 30/12; B60W 2050/0071; B60W 2040/0818; B60W 2540/18; B60W 2510/202; B60W 2710/20; B60W 10/20

(57) ABSTRACT

A computer includes a processor and a memory storing instructions executable by the processor to input steering torque data and steering wheel angle data to a machine learning program trained to output a status of a hand of an occupant relative to a steering wheel, the status being one of (1) the hand is on the steering wheel, (2) the hand is off the steering wheel and no weight is applied to the steering wheel, or (3) the hand is off the steering wheel and a weight is applied to the steering wheel, and actuate a steering subsystem when the output of the machine learning program indicates that the hand of the occupant is off the steering wheel.

### BACKGROUND

An occupant operating a vehicle typically can provide manual input to a steering subsystem, e.g., including a steering wheel, to steer the vehicle. Further, a computer in the vehicle could operate the steering subsystem without input from the occupant, e.g., in an autonomous or semi-autonomous mode. For example, in a lane centering support operation, the computer can actuate the steering subsystem to maintain the vehicle between markings of a roadway lane.

### BRIEF DESCRIPTION OF THE DRAWINGS

FIG. 1 is a block diagram of an example system for operating a vehicle.

FIG. 2 is a view of an example steering subsystem of the vehicle.

FIGS. 3A-3C illustrate statuses of a hand of an occupant relative to the steering wheel.

FIG. 4 is a diagram of an example neural network.

FIG. 5 is a block diagram of an example process for operating the vehicle.

### DETAILED DESCRIPTION

A system includes a computer including a processor and a memory, the memory storing instructions executable by the processor to input steering torque data and steering wheel angle data to a machine learning program trained to output a status of a hand of an occupant relative to a steering wheel, the status being one of (1) the hand is on the steering wheel, (2) the hand is off the steering wheel and no weight is applied to the steering wheel, or (3) the hand is off the steering wheel and a weight is applied to the steering wheel, and actuate a steering subsystem when the output of the machine learning program indicates that the hand of the occupant is off the steering wheel.

The input steering torque data and the input steering wheel angle data can be a plurality of sets of steering torque data and steering wheel angle data, each set can include steering torque data and steering wheel angle data for a specified period of time.

Timestamps of a portion of the specified period of time of a first set of steering torque data and steering wheel angle data can be same timestamps of a portion of the specified period of time of a second set of steering torque data and steering wheel angle data.

The instructions can further include instructions to provide an output to a speaker or a display when the output of the machine learning program indicates that the hand of the occupant is off the steering wheel.

The machine learning program can be a deep neural network.

The steering torque data and the steering wheel angle data can be time-series data input to the deep neural network to output the status of the hand.

The instructions further can include instructions to actuate a torque sensor to collect the steering torque data and to actuate an angle sensor to collect the steering wheel angle data.

The instructions can further include instructions to transition the steering subsystem to a manual mode when the output of the machine learning program indicates that the hand of the occupant is off the steering wheel.

The instructions can further include instructions to deactivate at least one of a cruise control subsystem or a lane centering subsystem upon transitioning the steering subsystem to the manual mode.

The instructions can further include instructions to transition the steering subsystem to a semiautonomous mode when, after transitioning the steering subsystem to the manual mode, the output of the machine learning program indicates that the hand of the occupant is on the steering wheel.

The instructions can further include instructions to output a probability distribution from the machine learning program, the probability distribution indicating respective probabilities that (1) the hand is on the steering wheel, (2) the hand is off the steering wheel and no weight is applied to the steering wheel, or (3) the hand off is the steering wheel and the weight is applied to the steering wheel.

The instructions can further include instructions to actuate the steering subsystem when the output of the machine learning program that the hand of the occupant is off the steering wheel for an elapsed time exceeding a time threshold.

A method includes inputting steering torque data and steering wheel angle data to a machine learning program trained to output a status of a hand of an occupant relative to a steering wheel, the status being one of (1) the hand on the steering wheel, (2) the hand off the steering wheel and no weight applied to the steering wheel, or (3) the hand off the steering wheel and a weight applied to the steering wheel, and actuating a steering subsystem when the output of the machine learning program indicates that the hand of the occupant is off the steering wheel.

The method can further include providing an output to a speaker or a display when the output of the machine learning program indicates that the hand of the occupant is off the steering wheel.

The method can further include actuating a torque sensor to collect the steering torque data and actuating an angle sensor to collect the steering wheel angle data.

The method can further include transitioning the steering subsystem to a manual mode when the output of the machine learning program indicates that the hand of the occupant is off the steering wheel.

The method can further include deactivating at least one of a cruise control subsystem or a lane centering subsystem upon transitioning the steering subsystem to the manual mode.

The method can further include transitioning the steering subsystem to a semiautonomous mode when, after transitioning the steering subsystem to the manual mode, the output of the machine learning program indicates that the hand of the occupant is on the steering wheel.

The method can further include outputting a probability distribution from the machine learning program, the probability distribution indicating respective probabilities that (1) the hand is on the steering wheel, (2) the hand is off the steering wheel and no weight is applied to the steering wheel, or (3) the hand off is the steering wheel and the weight is applied to the steering wheel.

The method can further include actuating the steering subsystem when the output of the machine learning program that the hand of the occupant is off the steering wheel for an elapsed time exceeding a time threshold.

Further disclosed is a computing device programmed to execute any of the above method steps. Yet further disclosed is a vehicle comprising the computing device. Yet further disclosed is a computer program product, comprising a computer readable medium storing instructions executable by a computer processor, to execute any of the above method steps.

When a computer in a vehicle operates a steering subsystem in an autonomous or semi-autonomous mode, an occupant of the vehicle may grasp a steering wheel to be ready to assume manual control. One or more sensors can detect whether the occupant's hands are on the steering wheel. For example, a torque sensor can detect a torque applied to the steering wheel, and if the applied torque is below a threshold determined by a vehicle dynamics model, the computer can provide an alert to the occupant requesting the occupant to grasp the steering wheel. In another example, a camera can collect image data of the steering wheel and, using an image processing technique such as Canny edge detection, the computer can determine whether the hands of the occupant are on the steering wheel. In yet another example, a capacitive sensor in the steering wheel can detect a change in capacitance when the occupant's hands are moved from the steering wheel. These techniques for detecting the hands of the occupant may be computationally costly to implement and/or may require additional hardware in the vehicle. Additionally, a weight placed on the steering wheel (such as a cup of coffee) may result in a torque in the steering wheel even when the hands of the occupant are not on the steering wheel, and the torque sensor may false positively detect the weight as a hand on the steering wheel.

Using a machine learning program trained to identify a status of the hands of the occupant from steering torque data and steering angle data can use existing sensors in the vehicle while accurately differentiating between the hands of the occupant on the steering wheel and a weight applied to the steering wheel, reducing false positive detections of the occupant's hands. Distinguishing between the occupant's hands on the wheel (during which the computer can operate the steering subsystem autonomously) and the weight applied to the steering wheel (during which the occupant should operate the steering subsystem manually) with the machine learning program can improve operation of the vehicle by determining an amount of autonomous control of the steering subsystem based on behavior of the occupant. The computer can identify the status of the occupant's hands relative to the steering wheel without additional hardware installed in the vehicle, such as cameras or capacitive sensors, that may require additional data collected and processed by the computer. Thus, the machine learning program can reduce the use of computationally costly image processing algorithms and/or additional capacitive sensors in a steering wheel to identify the status of the occupant's hands.

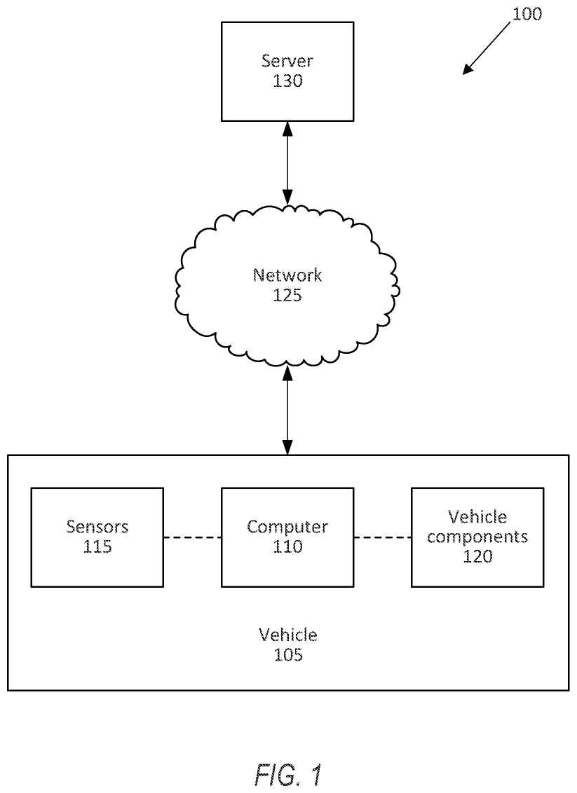

FIG. 1 illustrates an example system 100 for operating a vehicle 105. A computer 110 in the vehicle 105 is programmed to receive collected data from one or more sensors 115. For example, vehicle data may include a location of the vehicle 105, data about an environment around a vehicle 105, data about an object outside the vehicle 105 such as another vehicle 105, etc. A vehicle location is typically provided in a conventional form, e.g., geo-coordinates such as latitude and longitude coordinates obtained via a navigation system that uses the Global Positioning System (GPS). Further examples of data can include measurements of vehicle systems and components, e.g., a vehicle velocity, a vehicle trajectory, etc.

The computer 110 is generally programmed for communications on a vehicle network, e.g., including a conventional vehicle communications bus such as a CAN bus, LIN bus, etc., and or other wired and/or wireless technologies, e.g., Ethernet, WIFI, etc. Via the network, bus, and/or other wired or wireless mechanisms (e.g., a wired or wireless local area network in the vehicle 105), the computer 110 may transmit messages to various devices in a vehicle 105 and/or receive messages from the various devices, e.g., controllers, actuators, sensors, etc., including sensors 115. Alternatively or additionally, in cases where the computer 110 actually comprises multiple devices, the vehicle network may be used for communications between devices represented as the computer 110 in this disclosure. For example, the computer 110 can be a generic computer with a processor and memory as described above and/or may include a dedicated electronic circuit including an ASIC that is manufactured for a particular operation, e.g., an ASIC for processing sensor data and/or communicating the sensor data. In another example, computer 110 may include an FPGA (Field-Programmable Gate Array) which is an integrated circuit manufactured to be configurable by an occupant. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in computer 110.

In addition, the computer 110 may be programmed for communicating with the network, which, as described below, may include various wired and/or wireless networking technologies, e.g., cellular, Bluetooth®, Bluetooth® Low Energy (BLE), wired and/or wireless packet networks, etc.

The memory can be of any type, e.g., hard disk drives, solid state drives, servers, or any volatile or non-volatile media. The memory can store the collected data sent from the sensors 115. The memory can be a separate device from the computer 110, and the computer 110 can retrieve information stored by the memory via a network in the vehicle 105, e.g., over a CAN bus, a wireless network, etc. Alternatively or additionally, the memory can be part of the computer 110, e.g., as a memory of the computer 110.

Sensors 115 can include a variety of devices. For example, various controllers in a vehicle 105 may operate as sensors 115 to provide data via the vehicle network or bus, e.g., data relating to vehicle speed, acceleration, location, subsystem and/or component status, etc. Further, other sensors 115 could include cameras, motion detectors, etc., i.e., sensors 115 to provide data for evaluating a position of a component, evaluating a slope of a roadway, etc. The sensors 115 could, without limitation, also include short range radar, long range radar, LIDAR, and/or ultrasonic transducers.

Collected data can include a variety of data collected in a vehicle 105. Examples of collected data are provided above, and moreover, data are generally collected using one or more sensors 115, and may additionally include data calculated therefrom in the computer 110, and/or at the server 130. In general, collected data may include any data that may be gathered by the sensors 115 and/or computed from such data.

The vehicle 105 can include a plurality of vehicle components 120. In this context, each vehicle component 120 includes one or more hardware components adapted to perform a mechanical function or operation—such as moving the vehicle 105, slowing or stopping the vehicle 105, steering the vehicle 105, etc. Non-limiting examples of components 120 include a propulsion component (that includes, e.g., an internal combustion engine and/or an electric motor, etc.), a transmission component, a steering subsystem as described below (e.g., that may include one or more of a steering wheel, a steering rack, etc.), a brake component, a park assist component, an adaptive cruise control component, an adaptive steering component, a movable seat, and the like. Components 120 can include computing devices, e.g., electronic control units (ECUs) or the like and/or computing devices such as described above with respect to the computer 110, and that likewise communicate via a vehicle network.

A vehicle 105 can operate in one of a fully autonomous mode, a semiautonomous mode, or a non-autonomous mode. A fully autonomous mode is defined as one in which each of vehicle propulsion (typically via a powertrain including an electric motor and/or internal combustion engine), braking, and steering are controlled by the computer 110. A semi-autonomous mode is one in which at least one of vehicle propulsion (typically via a powertrain including an electric motor and/or internal combustion engine), braking, and steering are controlled at least partly by the computer 110 as opposed to a human operator. In a non-autonomous mode, i.e., a manual mode, the vehicle propulsion, braking, and steering are controlled by the human operator.

The system can further include a network 125 connected to a server 130. The computer 110 can further be programmed to communicate with one or more remote sites such as the server 130, via the network 125, such remote site possibly including a processor and a memory. The network 125 represents one or more mechanisms by which a vehicle computer 110 may communicate with a remote server 130. Accordingly, the network 125 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks 125 include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

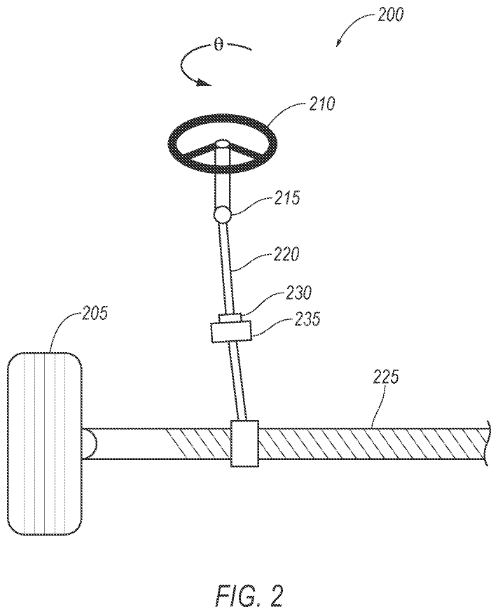

FIG. 2 is a diagram of an example steering subsystem 200. The steering subsystem 200 can receive input from an occupant to steer the vehicle 105. The steering subsystem 200 can transfer input from the occupant to wheels 205 of the vehicle 105 to govern a vehicle path, e.g., turning the vehicle 105. An electronic control unit (not shown) of the steering subsystem 200 can be in communication with and receive input from the computer 110. The steering subsystem 200 may include a rack-and-pinion system with electric power-assisted steering, a steer-by-wire system, etc.

The steering subsystem 200 includes a steering wheel 210. The user provides input to the steering wheel 210 to steer the vehicle 105. The steering subsystem 200 transfers rotational input of the steering wheel 210 to rotation of the wheels 205 to turn the vehicle 105. The occupant can rotate the steering wheel 210 to a steering wheel angle θ. The “steering wheel angle” θ is a measure of a rotation of the steering wheel 210 from a neutral position. The “neutral position” is typically a default position of the steering wheel 210 at which the vehicle 105 is provided input from the steering wheel 210 to move forward without turning. The steering subsystem 200 includes a steering wheel angle sensor 215. The steering wheel angle sensor 215 detects the steering wheel angle θ of the steering wheel 210, i.e., collects “steering wheel angle” data including the angle θ at one or more times. The computer 110 can instruct the steering wheel angle sensor 215 to collect the steering wheel angle data.

The steering subsystem 200 includes a steering column 220. The steering column 220 transfers rotational motion of the steering wheel to translational motion of a steering rack 225. The steering column 220 can be, e.g., a shaft connecting the steering wheel 210 to the steering rack 225. The steering subsystem 200 includes a steering torque sensor 230 supported by the steering column 220. The steering torque sensor 230 measures torque applied to the steering column 220, i.e., collects “steering torque” data. The computer 110 can instruct the steering torque sensor 230 to collect the steering torque data.

The steering subsystem 200 includes a steering motor 235. The steering motor 235 provides additional torque to rotate the steering column 220, assisting the occupant in steering the vehicle 105. The steering motor 235 can thus be a steering assist motor. The steering motor 235 provides additional torque that the occupant would otherwise provide, allowing the occupant to steer the vehicle 105 with less input force than without the steering motor 235. The steering torque sensor 230 detects torque applied by the occupant turning the steering wheel 210. The steering torque sensor 230 detects a relative position between an input shaft of the steering column 220 and an output shaft of the steering column 220 connected by a torsion bar therebetween, i.e., an amount of twist of the torsion bar of the steering column 220. The steering torque sensor 230 can determine the relative position by, e.g., measuring a change magnetization of the steering column 220 caused by the twisting of the steering column 220, measuring a change of electromagnetic induction of the steering column 220 caused by twisting the torsion bar, etc. Upon detecting the amount of twist of the steering column 220, the steering torque sensor 230 can determine the torque applied to the steering column 220 based on conventional elastic deformation methods and material properties of the steering column 220.

The computer 110 can instruct the steering wheel angle sensor 215 and the steering torque sensor 230 to collect the steering wheel angle data and the steering torque data as “time series” data. In this context, time series data are a set of data in which timestamps at which the data were collected are within a predetermined time period, e.g., 2 seconds. The computer 110 can organize the steering torque data and the steering angle data into a plurality of sets of data, each set including steering torque data and steering angle data for the specified period of time. For example, each set of time series data can include a single datum of the steering torque that is an arithmetic mean of the steering torque data collected during the specified period of time and a single datum of the steering when angle data that is an arithmetic of the steering wheel angle data collected during the specified period of time. In another example, each set of time series data can include a plurality of steering torque data collected at different times during the specified period of time and a plurality of steering wheel angle data collected at different times during the specified period of time. The time series data track changes to the steering wheel angle θ and the steering torque over the specified period of time. For example, the time series data can describe a sharp increase to the steering wheel angle θ in one set of data and a return to a previous steering wheel angle θ in a subsequent set of data.

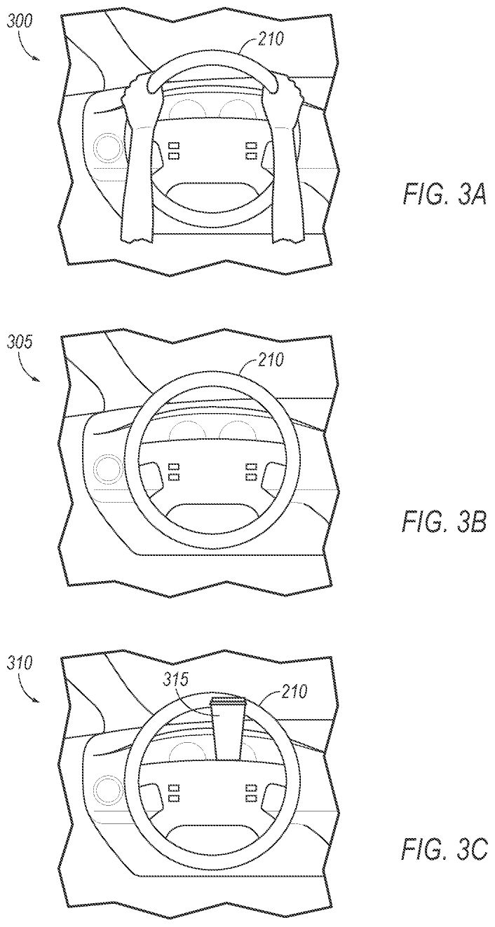

FIGS. 3A-3C illustrate statuses of a hand of an occupant in the vehicle 105 with respect to a steering wheel 210, which, as described further below, could be output from a machine learning program based on steering wheel data such as angle data and torque data. FIG. 3A shows a status 300 of the hand on the steering wheel 210. FIG. 3B shows a status 305 of the hand off of the steering wheel 210. FIG. 3C shows a status 310 the hand off of the steering wheel 210, but a weight 315 applied to the steering wheel 210. A “weight” 315 is an object, e.g., a user's smartphone, beverage container, etc., that can induce a torque on the steering wheel 210 detectable by the steering torque sensor 230. When a weight 315 is applied to the steering wheel, the steering subsystem 200 can advantageously determine whether the weight 315 is caused by a hand or hands of the occupant, or by application of some other object, e.g., a mug, cup, smartphone, etc. The computer 110 can identify the status 300, 305, 310 of the hand relative to the steering wheel 210. In this context, the “status” is the location of the hand relative to the steering wheel 210, the location representing the action that the hand is performing, i.e., whether the occupant is grasping the steering wheel 210. The status of the hand can be one of: (1) the hand is on the steering wheel 210, the status 300 as shown in FIG. 3A, (2) the hand is off the steering wheel 210, the status 305 as shown in FIG. 3B, or (3) the hand is off the steering wheel 210 and a weight 315 is applied to the steering wheel 210, the status 310 as shown in FIG. 3C.

The computer 110 can input the steering torque data and the steering wheel angle data to a machine learning program, such as a deep neural network 400 described below, that is trained to output the status 300, 305, 310 of the hand of the occupant. The machine learning program is stored in the computer 110. The machine learning program receives the time series steering torque data and steering wheel angle data as input, and outputs a status of the hand based on the steering torque data and the steering wheel angle data. Example inputs to the machine learning program and outputs from the machine learning program are shown in Table 1 below:

TABLE 1
Status Detection

| Steering | Steering Angle | |
|---|---|---|
| Torque (N-m) | (degrees) | Status |
| 1.10 | 1.3 | Hand On |
| 0.60 | −0.6 | Hand On |
| 0.05 | −0.3 | Hand Off, No Weight |
| 0.01 | −0.1 | Hand Off, No Weight |
| 0.25 | 0.4 | Weight On |
| 0.50 | 0.7 | Weight On |

The machine learning program can output a probability distribution of each status 300, 305, 310. The probability distribution indicates respective probabilities for each status 300, 305, 310, including a probability that the occupant's hand is on the steering wheel 210, a probability that the occupant's hand is off the steering wheel 210 with no weight 315 applied to the steering wheel 210, and the occupant's hand is off is the steering wheel 210 and the weight 315 is applied to the steering wheel 210. The computer 110 can operate the vehicle 105 based on the status 300, 305, 310 having a highest probability. That is, the output status 300, 305, 310 of the occupant's hand can be the status 300, 305, 310 having the highest probability in the probability distribution.

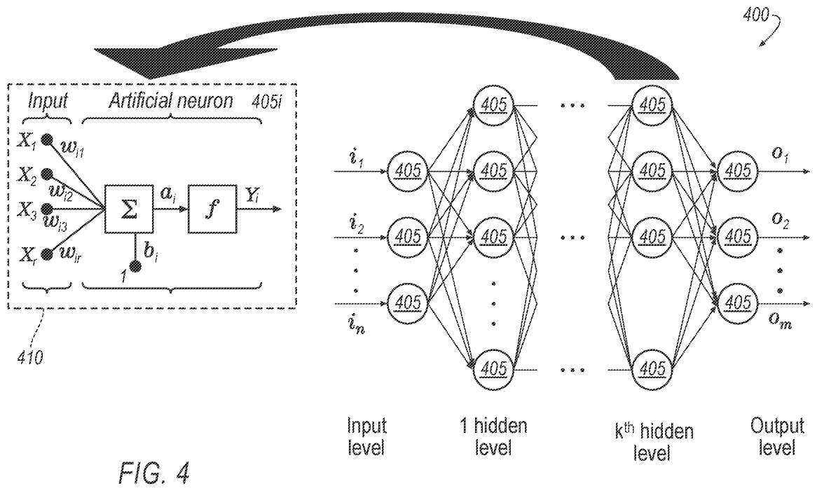

The machine learning program can be trained with reference time series data to distinguish between the statuses 300, 305, 310 of the hand. The machine learning program can be trained to distinguish between the hand of the occupant on the steering wheel 210, as shown in FIG. 3A, and a weight 315 applied to the steering wheel 210, as shown in FIG. 3C. That is, the machine learning program can distinguish between statuses 300, 305, 310 of the hand that steering torque sensor alone may not distinguish. The reference time series data can include annotations indicating the status 300, 305, 310 of the hand of the occupant. For example, reference time series data collected when the hand of the occupant was on the steering wheel 210 can include a label indicating the status 300 of the hand of the occupant as on the steering wheel 210. Thus, for training a neural network 400, as shown in FIG. 4, reference time series data can be collected for statuses 300, 305, 310 of the hand and labels included in the time series data indicating the respective statuses 300, 305, 310 during which the reference data were collected.

Upon identifying the status of the hand of the occupant, the computer 110 can actuate one or more components 120 based on the identified status. A computer 110 may be programmed to operate the vehicle 105 in an autonomous mode or a semiautonomous mode only when the hands of the occupant are on the steering wheel 210. When the status is the hand is on the steering wheel, as shown in FIG. 3A, the computer 110 can continue to operate the components 120 in a current operation mode. For example, if the computer 110 operates the steering subsystem 200 in a semiautonomous mode, the computer 110 can continue to operate the steering subsystem 200 in the semiautonomous mode. In another example, if the computer 110 operates the steering subsystem 200 in a fully autonomous mode, the computer 110 can continue to operate the steering subsystem 200 in the fully autonomous mode.

When the status 305, 310 is the hand is off the steering wheel, either with a weight 315 applied to the steering wheel 210 or no weight 315 is applied to the steering wheel 210, the computer 110 can transition one or more components 120 to a manual mode. Because the computer 110 can be programmed not to operate the vehicle 105 in the autonomous or semiautonomous modes without hands of the occupant on the steering wheel 210, the computer 110 can deactivate one or more components 120 to slow and stop the vehicle 105 until the occupant returns a hand to the steering wheel 210. That is, when the hand of the occupant is off of the steering wheel 210, the computer 110 can transition the vehicle 105 from a fully autonomous mode or a semiautonomous mode to a manual mode, and the vehicle 105 can slow to a stop until the occupant can resume manual control of the vehicle 105. For example, the computer 110 can transition the steering subsystem 200 to manual control, receiving input only from the occupant. In another example, the computer 110 can deactivate a cruise control subsystem that actuates a propulsion to maintain a specified vehicle speed. In another example, the computer 110 can deactivate a lane centering subsystem that actuates the steering subsystem 200 to maintain the vehicle 105 between roadway lane markings.

Additionally or alternatively, the computer 110 can provide one or more outputs to instruct the occupant to place a hand on the steering wheel 210. The computer 110 can provide an output to a speaker or a display in the vehicle 105 with an audio or visual message requesting the occupant to grasp the steering wheel 210. The computer 110 can actuate the steering subsystem 200 and/or other provide outputs upon a single detection that the hand of the occupant is off the steering wheel 210. Alternatively, the computer 110 can actuate the steering subsystem 200 and/or provide the outputs when the output of the machine learning program is that the hand of the occupant is off the steering wheel 210 for an elapsed time exceeding a time threshold. The time threshold can be determined such that single indications of the hand off the steering wheel 210 do not trigger actuation by the computer 110, but indications that the occupant has removed the hands from the steering wheel 210 for a period of time exceeding a typical time to react to an action requiring steering. For example, the time threshold can be based on empirical testing of occupant reaction times to objects in a roadway that require steering, and the time threshold can be a minimum reaction time for an occupant to grasp the steering wheel 210.

When, in a manual mode of a vehicle 105, the hand status output from the machine learning program is that the occupant's hands are on the steering wheel 210, the computer 110 can transition the steering subsystem 200 to a semiautonomous mode. Because the occupant's hands are on the wheel, the computer 110 can provide input to operate the steering subsystem 200 without input from the occupant. For example, the computer 110 can operate the lane centering subsystem to maintain the vehicle 105 within markings of a roadway lane.

FIG. 4 is a diagram of an example a deep neural network (DNN) 400. The machine learning program described above may be a deep neural network such as the DNN 400. That is, the machine learning program may be trained according to the conventional deep learning techniques described below. The DNN 400 can be trained in a server 130 and sent to the computer 110 of the vehicle 105 via, e.g., the network 125.

The DNN 400 can be a software program that can be stored in a memory and executed by a processor included in the computer 110 of the vehicle 105, for example. The DNN 400 can include n input nodes 405, each accepting a set of inputs i (i.e., each set of inputs i can include one or more inputs X). The DNN 400 can include m output nodes (where m and n may be, but typically are not, a same natural number) provide sets of outputs o₁ . . . oₘ. The DNN 400 includes a plurality of layers, including a number k of hidden layers, each layer including one or more nodes 405. The nodes 405 are sometimes referred to as artificial neurons 405, because they are designed to emulate biological, e.g., human, neurons. The neuron block 410 illustrates inputs to and processing in an example artificial neuron 405i. A set of inputs X₁ . . . Xᵣ to each neuron 405 are each multiplied by respective weights wᵢ₁ . . . wᵢᵣ, the weighted inputs then being summed in input function Σ to provide, possibly adjusted by a bias bᵢ, net input aᵢ, which is then provided to activation function ƒ, which in turn provides neuron 405i output Yᵢ. The activation function ƒ can be a variety of suitable functions, typically selected based on empirical analysis. As illustrated by the arrows in FIG. 4, neuron 405 outputs can then be provided for inclusion in a set of inputs to one or more neurons 405 in a next layer.

The DNN 400 can be trained to receive input data, e.g., time series data of steering angle data and steering torque data, and to then provide output based on that input. That is, the DNN 400 can be trained with ground truth data, i.e., data deemed to describe a real-world condition or state. Weights w can be initialized by using a Gaussian distribution, for example, and a bias b for each node 405 can be set to zero. Training the DNN 400 can including updating weights and biases via conventional techniques such as back-propagation with optimizations.

A set of weights w for a node 405 together are a weight vector for the node 405. Weight vectors for respective nodes 405 in a same layer of the DNN 400 can be combined to form a weight matrix for the layer. Bias values b for respective nodes 405 in a same layer of the DNN 400 can be combined to form a bias vector for the layer. The weight matrix for each layer and bias vector for each layer can then be used in the trained DNN 400.

In the present context, the ground truth data used to train the DNN 400 could include the time series data described above. For example, a computer 110 can use data from the steering angle sensor 215 and the steering torque sensor 230 that can be labeled for training the DNN 400, i.e., tags can be specified identifying the status 300, 305, 310 of the hand relative to the steering wheel 210. The DNN 400 can then be trained to output data values that correlate to a predicted hand status, and the output data values can be compared to the annotations to identify a difference, i.e., a cost function of the output data values and the input annotated time series data. The weights w and biases b can be adjusted to reduce the output of the cost function, i.e., to minimize the difference between the output data values and the annotations in the input time series data. When the cost function is minimized, the server 130 can determine that the DNN 400 is trained.

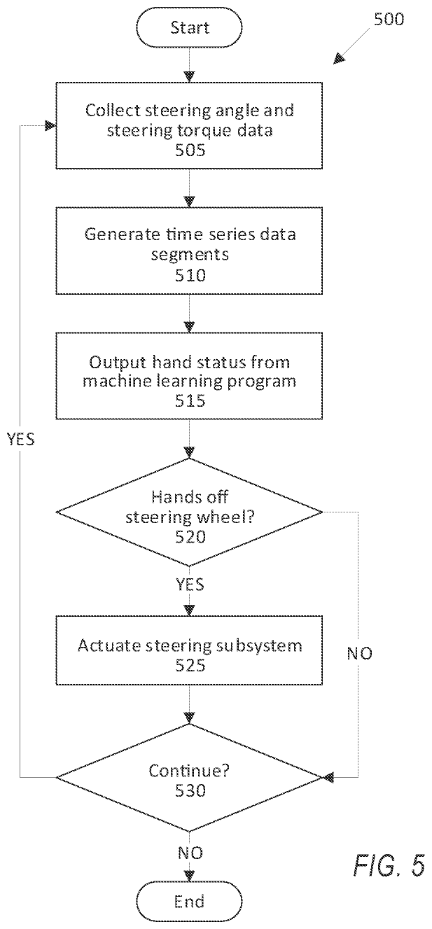

FIG. 5 is a block diagram of an example process 500 for operating a vehicle 105, carried out according to instructions stored in a memory of, and executed by a processor of, a computer 110 in a vehicle 105. The process 500 begins in a block 505, in which a computer 110 in a vehicle 105 actuates a steering torque sensor 230 in a steering subsystem 200 to collect steering torque data and a steering wheel angle sensor 215 to collect steering wheel angle data. The steering torque sensor 230 measures torque applied to a steering column 220. The steering wheel angle sensor 215 measures an angle θ of a steering wheel 210 rotated away from a neutral position.

Next, in a block 510, the computer 110 generates time series data sets. As described above, the computer 110 can generate set of the steering torque data and the steering wheel angle data, each set containing data collected within a specified period of time, e.g., 2 seconds. The collected data include timestamps indicating when the sensors 215, 230 collected the data, and the computer 110 can generate each set such that data with timestamps within a specified period of time are included in a same set.

Next, in a block 515, the computer 110 inputs the time series data to a machine learning program that outputs a status 300, 305, 310 of a hand of an occupant of the vehicle 105. As described above, the hand status 300, 305, 310 indicates a location of the hand of the occupant relative to the steering wheel 210. The machine learning program can be a deep neural network 400, as described above, trained to output one of three statuses: the hand of the occupant is on the steering wheel 210 shown as status 300 in FIG. 3A, the hand of the occupant is off of the steering wheel 210 and no weight 315 is applied to the steering wheel 210 shown as status 305 in FIG. 3B, and the hand of the occupant is off of the steering wheel 210 and a weight 315 is applied to the steering wheel 210 shown as status 310 in FIG. 3C. A steering torque sensor 230 alone may identify the weight 315 applied to the steering wheel 210 as a hand on the steering wheel 210 because the weight 315 can apply a torque to the steering wheel 210 resulting in rotation of the steering column 220 detected by the steering torque sensor 230. The machine learning program can be trained to distinguish, based on the steering torque data and the steering wheel angle data, when a weight 315 is applied to the steering wheel 210 that is not a hand. The machine learning program thus prevents false positive detections of the weight 315 as a hand on the steering wheel 210.

Next, in a block 520, the computer 110 determines whether the hand of the occupant is off of the steering wheel 210. The computer 110 determines whether the status of the hand is one of the statuses 305, 310, in which the hand of the occupant is off of the steering wheel 210. If identified status indicates that the hand is off of the steering wheel 210, the process 500 continues in a block 525. Otherwise, the process 500 continues in a block 530.

In the block 525, the computer 110 actuates the steering subsystem 200. The computer 110 can transition the steering subsystem 200 from a fully autonomous mode to a semiautonomous mode or a manual mode in which the occupant provides manual input to the steering subsystem 200. The computer 110 can deactivate a lane centering subsystem and/or a cruise control subsystem, and the occupant can provide manual input to steer the vehicle 105.

In the block 530, the computer 110 determines whether to continue the process 500. For example, the computer 110 can determine to continue the process 500 when the vehicle 105 remains on a path toward a destination. The computer 110 can determine not to continue the process 500 when the vehicle 105 is powered off. If the computer 110 determines to continue, the process 500 returns to the block 505. Otherwise, the process 500 ends.

Computing devices discussed herein, including the computer 110, include processors and memories, the memories generally each including instructions executable by one or more computing devices such as those identified above, and for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Python, Perl, HTML, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in the computer 110 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non volatile media, volatile media, etc. Non volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 500, one or more of the steps could be omitted, or the steps could be executed in a different order than shown in FIG. 5. In other words, the descriptions of systems and/or processes herein are provided for the purpose of illustrating certain embodiments and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

1. A system, comprising a computer including a processor and a memory, the memory storing instructions executable by the processor to:
input steering torque data and steering wheel angle data to a machine learning program trained to output a status of a hand of an occupant relative to a steering wheel, the status being one of (1) the hand is on the steering wheel, (2) the hand is off the steering wheel and no weight is applied to the steering wheel, or (3) the hand is off the steering wheel and a weight is applied to the steering wheel; and
actuate a steering subsystem when the output of the machine learning program indicates that the hand of the occupant is off the steering wheel.

2. The system of claim 1, wherein the input steering torque data and the input steering wheel angle data are a plurality of sets of steering torque data and steering wheel angle data, each set including steering torque data and steering wheel angle data for a specified period of time.

3. The system of claim 2, wherein timestamps of a portion of the specified period of time of a first set of steering torque data and steering wheel angle data are same timestamps of a portion of the specified period of time of a second set of steering torque data and steering wheel angle data.

4. The system of claim 1, wherein the instructions further include instructions to provide an output to a speaker or a display when the output of the machine learning program indicates that the hand of the occupant is off the steering wheel.

5. The system of claim 1, wherein the machine learning program is a deep neural network.

6. The system of claim 5, wherein the steering torque data and the steering wheel angle data are time-series data input to the deep neural network to output the status of the hand.

7. The system of claim 1, wherein the instructions further include instructions to actuate a torque sensor to collect the steering torque data and to actuate an angle sensor to collect the steering wheel angle data.

8. The system of claim 1, wherein the instructions further include instructions to transition the steering subsystem to a manual mode when the output of the machine learning program indicates that the hand of the occupant is off the steering wheel.

9. The system of claim 8, wherein the instructions further include instructions to deactivate at least one of a cruise control subsystem or a lane centering subsystem upon transitioning the steering subsystem to the manual mode.

10. The system of claim 8, wherein the instructions further include instructions to transition the steering subsystem to a semiautonomous mode when, after transitioning the steering subsystem to the manual mode, the output of the machine learning program indicates that the hand of the occupant is on the steering wheel.

11. The system of claim 1, wherein the instructions further include instructions to output a probability distribution from the machine learning program, the probability distribution indicating respective probabilities that (1) the hand is on the steering wheel, (2) the hand is off the steering wheel and no weight is applied to the steering wheel, or (3) the hand off is the steering wheel and the weight is applied to the steering wheel.

12. The system of claim 1, wherein the instructions further include instructions to actuate the steering subsystem when the output of the machine learning program that the hand of the occupant is off the steering wheel for an elapsed time exceeding a time threshold.

13. A method, comprising:
inputting steering torque data and steering wheel angle data to a machine learning program trained to output a status of a hand of an occupant relative to a steering wheel, the status being one of (1) the hand on the steering wheel, (2) the hand off the steering wheel and no weight applied to the steering wheel, or (3) the hand off the steering wheel and a weight applied to the steering wheel; and
actuating a steering subsystem when the output of the machine learning program indicates that the hand of the occupant is off the steering wheel.

14. The method of claim 13, wherein the input steering torque data and the input steering wheel angle data are a plurality of sets of steering torque data and steering wheel angle data, each set including steering torque data and steering wheel angle data for a specified period of time.

15. The method of claim 14, wherein timestamps of a portion of the specified period of time of a first set of steering torque data and steering wheel angle data are same timestamps of a portion of the specified period of time of a second set of steering torque data and steering wheel angle data.

16. The method of claim 13, further comprising providing an output to a speaker or a display when the output of the machine learning program indicates that the hand of the occupant is off the steering wheel.

17. The method of claim 13, further comprising actuating a torque sensor to collect the steering torque data and to actuating an angle sensor to collect the steering wheel angle data.

18. The method of claim 13, further comprising transitioning the steering subsystem to a manual mode when the output of the machine learning program indicates that the hand of the occupant is off the steering wheel.

19. The method of claim 18, further comprising deactivating at least one of a cruise control subsystem or a lane centering subsystem upon transitioning the steering subsystem to the manual mode.

20. The method of claim 18, further comprising transitioning the steering subsystem to a semiautonomous mode when, after transitioning the steering subsystem to the manual mode, the output of the machine learning program indicates that the hand of the occupant is on the steering wheel.
